(19) United States
(12) Patent Application Publication
(10) Pub. No.: US 2015/0332225 A1
(43) Pub. Date: Nov. 19, 2015

(54) SYSTEM AND METHOD FOR SHARING MEDIA ITEMS

(71) Applicant: Matthew Earl Schulz, Henderson, NV (US)

(72) Inventor: Matthew Earl Schulz, Henderson, NV (US)

(21) Appl. No.: 14/712,464

(22) Filed: May 14, 2015

Related U.S. Application Data
(60) Provisional application No. 61/993,381, filed on May 15, 2014.

(51) Int. Cl. G06Q 20/08; H04L 29/06

(52) U.S. Cl. CPC G06Q 20/085; H04L 65/60

(57) ABSTRACT

A system and method for sharing media items. In one embodiment, the invention can be a system including a customer interface portal configured to receive from a first user a chosen media list; and receive a request from the first user to provide the chosen media list to a second user; an account management server configured to send to the second user the chosen media list; receive a licensed media list from a second user device; compare the licensed media list to the chosen media list and identify at least one common media item; and calculate a cost for the provision of the chosen media list to the second user, the cost including a charge for each media item of the at least one chosen media item not including the at least one common media item.

### CROSS-REFERENCE TO RELATED APPLICATIONS

The present application claims priority to U.S. Provisional Patent Application No. 61/993,381 filed May 15, 2014, the entirety of which is incorporated herein by reference.

### BACKGROUND

Personal computer devices are popular tools for downloading and playing digital media content encompassing electronic information that is generally subject to copyright or other legal protection. Consumers in this digital environment, however, are unable to offer and share media files with other users over the Internet in an efficient and cost effective manner. Certain prior art systems, for example, allow a user to purchase media files for another, but do not consider that the recipient may already own a license to one or more of the media files being shared. Thus, a user looking to gift music to a friend may be purchasing songs the recipient has already licensed without a reduction in cost or any other recognition that a song is already owned by the recipient.

Other prior art systems disclose a method of comparing and matching access rights to individual digital media content files on a network. But these systems do not allow the transaction to proceed when a common item is identified, nor do they allow the media content to be used by the recipient without accessing the network. Thus, there exists a need for a more efficient and cost effective system and method for lawfully sharing media items where transactions are permitted regardless of common items identified and where the media items are owned by a recipient upon downloading and can be used without further accessing the network.

### BRIEF SUMMARY

The present invention is directed to a system and method for sharing media items. In one embodiment, the invention can be a system for sharing media items, the system including a customer interface portal configured to receive from a first user a chosen media list identifying at least one chosen media item; receive a request from the first user to provide the chosen media list to a second user; an account management server configured to send to the second user the chosen media list; receive a licensed media list from a second user device, the licensed media list identifying licensed media items maintained by the second user device, the licensed media items being owned by the second user; compare the licensed media list of the second user to the chosen media list of the first user and identifying at least one common media item, the at least one common media item being common to both the licensed media list and the chosen media list; calculate a cost for the provision of the chosen media list to the second user, the cost including a charge for each media item of the at least one chosen media item not including the at least one common media item; confirm payment of the cost by the first user; calculate and issue a service fee to a content provider; and transfer to the second user for download each media item of the at least one chosen media item not including the at least one common media item.

In another embodiment, the invention can be a method for sharing media items, the method including receiving from a first user a chosen media list identifying at least one chosen media item; receiving a request from the first user to provide the chosen media list to a second user; sending to the second user the chosen media list; receiving a licensed media list from a second user device, the licensed media list identifying licensed media items maintained by the second user device, the licensed media items being owned by the second user; comparing the licensed media list of the second user with the chosen media list of the first user to identify at least one common media item; calculating a cost for the provision of the chosen media list to the second user, the cost including a charge for each media item of the at least one chosen media item not including the at least one common media item; confirming payment of the cost by the first user; calculating and issuing a service fee to a content provider; and transferring to the second user for download each media item of the at least one chosen media item not including the at least one common media item.

In another embodiment, the invention can be a method for sharing media items, the method including receiving from a first user a chosen media list identifying at least one chosen media item; receiving a request from the first user to provide the chosen media list to a second user; sending to the second user the chosen media list; receiving a licensed media list from a second user device, the licensed media list identifying licensed media items maintained by the second user device, the licensed media items being owned by the second user; comparing the licensed media list of the second user with the chosen media list of the first user to identify at least one common media item; calculating a cost for the provision of the chosen media list to the second user, the cost including a charge for each media item of the at least one chosen media item and a discounted charge for each of the at least one common media item; confirming payment of the cost by the first user; calculating a cost for the provision of the chosen media list to the second user, the cost including (a) a first charge for each of the at least one common media item, and (b) a second charge for each of the at least one chosen media item that is not the at least one common media item, wherein the first charge is less than the second charge; confirming payment of the cost by the first user; and transferring to the second user for download each media item of the at least one chosen media item not including the at least one common media item.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a system according to an embodiment of the invention.

FIG. 2 is a flow chart for a process according to an embodiment of the invention.

FIG. 3 is a block diagram of an account management server according to an embodiment of the invention.

FIG. 4 is a block diagram of a media catalog server according to an embodiment of the invention.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of the exemplary embodiments of the invention disclosed herein, any reference to direction or orientation is merely intended for convenience of description and is not intended in any way to limit the scope of the present invention. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. Moreover, the features and benefits of the invention are described by reference to the exemplary embodiments illustrated herein. Accordingly, the invention expressly should not be limited to such exemplary embodiments, even if indicated as being preferred. The discussion herein describes and illustrates some possible non-limiting combinations of features that may exist alone or in other combinations of features. The scope of the invention is defined by the claims appended hereto.

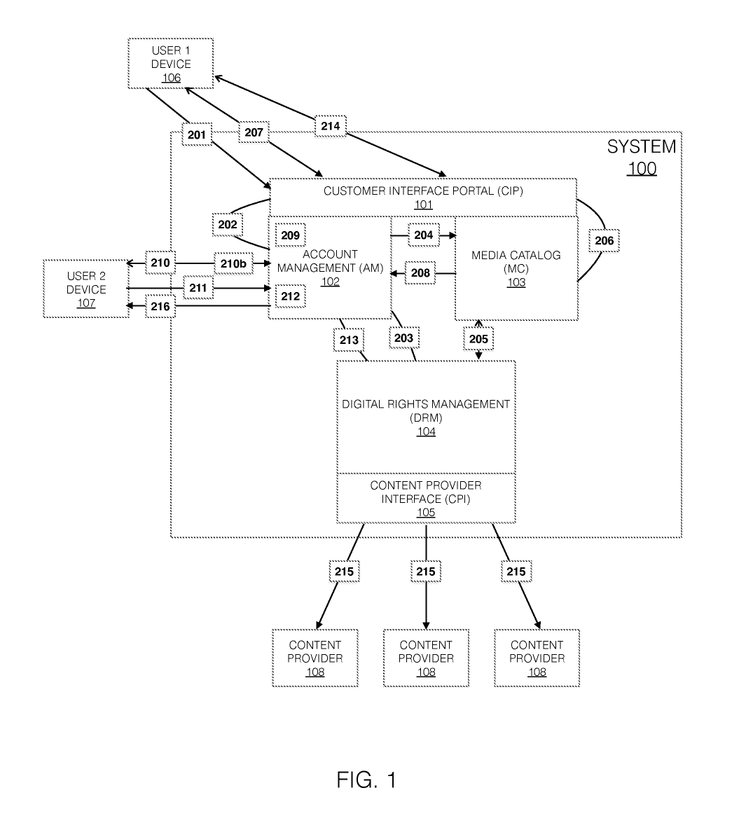

Referring now to FIG. 1, a block diagram of a system according to an embodiment of the invention is shown. The system 100 includes an account management (AM) server 102 configured to operate in conjunction with a media catalog (MC) server 103 and a digital rights management (DRM) server 104 to enable the sharing of media content between registered user devices 106, 107 through a customer interface portal (CIP) 101.

As used herein, the term “server” can refer to any computer or device on a network that manages network resources and/or provides services or data used by other computers. The configuration of servers, portals, and interfaces described herein represents but one embodiment of the claimed invention. Each server and other device discussed herein can include a processor. The processor may be any type of properly programmed processing device, such as a computer or microprocessor, configured for executing computer program instructions (e.g. code). The processor may be embodied in computer and/or server hardware of any suitable type (e.g. desktop, laptop, notebook, tablets, cellular phones, etc.) and may include all the usual ancillary components necessary to form a functional data processing device, including without limitation, software and data storage with volatile and non-volatile memory, input/output devices, graphical user interfaces (GUIs), removable data storage, and wired and/or wireless communication interface devices, including Wi-Fi, Bluetooth, LAN, etc. The processor is configured with specific algorithms to carry out its functions.

A “user device” as discussed herein can be any type of computer or other processor that can communicate with other devices through the Internet or an alternative electronic communication means. For example, the device can be a desktop computer, a laptop, a tablet, or a smartphone. Further, the computers, servers, and systems discussed herein can include obvious elements, such as memory and power supplies, that are not shown in the drawings, as their illustration is not required for an understanding of the invention.

The system further includes a customer interface portal (CIP) 101 for providing each user access to an available media catalog. In the exemplified embodiment, the available media catalog contains each user's licensed content registered with the system and any other content on the system that may be available from content providers for each user to share. The licensed content registered with the system can include unique media items stored on a registered user's device (or otherwise maintained by the user, such as in cloud storage), the unique media items being items not included in the plurality of system available media items. In other embodiments, the available media catalog can simply be those media items maintained by the user, or simply system available media items. Media content sourced from content providers can be made available on the system for download from the content providers via the content provider interface (CPI) 105.

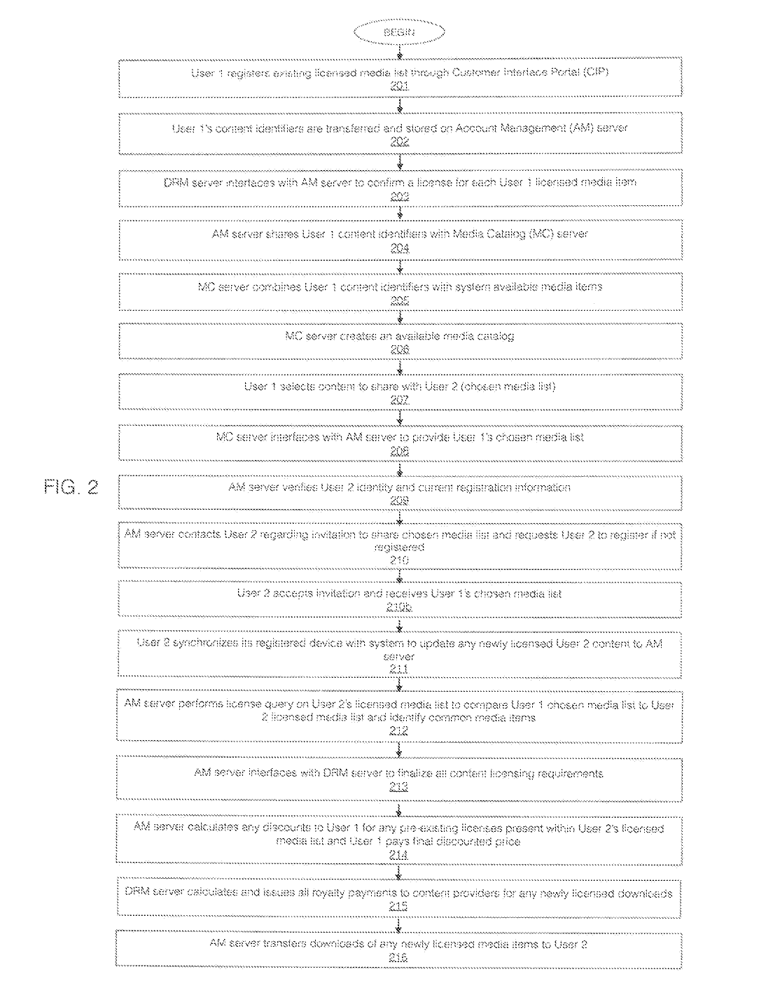

FIGS. 1 and 2 depict an exemplary operation of the digital media content sharing process. It is noted that the steps identified in the flowchart of FIG. 2 are also shown in the system block diagram of FIG. 1. In step 201 of the exemplified embodiment, the first user licensed media list and device 106 are registered with the system through the customer interface portal (CIP) 101, where the first user licensed media list identifies a plurality of first user media items licensed and maintained by the first user device 106. As used herein, the term “maintained” can refer to media items stored on the device or media items stored elsewhere (such as in the cloud) but capable of being controlled by the device. In other embodiments, such as where the media items are chosen from system available media items, this step can be omitted.

In step 202, the content identifiers of the first user's licensed media list are transferred and stored on the account management (AM) server 102 of the system. In step 203, the digital rights management (DRM) server 104 can interface with the AM server to confirm a license for each media item of the first user licensed media list.

In step 204 of the exemplified embodiment, the AM server interfaces with the media catalog (MC) server 103 and provides the content identifiers for each licensed media items from first user's existing licensed media list. In step 205, the MC server 103 combines the first user licensed media list with all other media content available for license from all content providers 108 associated with the system and in step 206 creates an available media catalog for the first user to share with other users. Then, in step 207, the first user's registered device 106 obtains the available media catalog from the system through CIP 101 and the first user device 106 can then select content to share with another user (second user device 107). The content to share is sometimes referred to as a chosen media list, the chosen media list identifying at least one chosen media item to be shared. A media item can be any item of digitally stored content, including songs, movies, television shows, and documentaries. In the exemplified embodiment, the media items are songs stored in MP3 or a comparable format, and the chosen media list is a playlist of songs. The first user can submit a request to provide the chosen media list to the second user. The request can be any method of electronically communicating with the system a desire to share the chosen media list.

In step 208, the MC server 103 interfaces with the AM server 102 to provide the first user's chosen media list to be shared with the second user. The AM server 102 verifies the second user's identity and registration information in step 209. In step 210, the AM server 102 contacts the second user device 107 over the Internet or by another electronic means (including wired or wireless means), preferably by electronic mail, to provide the second user an invitation to receive the chosen media list of the first user. If the second user is not a registered user of the system, then a request to register with the system can be added to the second user message. In step 210b, the second user can accept the invitation to receive the chosen media list, at which point the chosen media list is sent to the second user. In other embodiments, the chosen media list can be sent at a different stage in the process, such as when media items requiring a license are being downloaded. Also, in certain embodiments, the media list can be sent to the second user device 107 absent an invitation to share the chosen media list. For example, in some embodiments, if the second user has identified a first user as a trusted user, the chosen media playlist can be received automatically, without need for acceptance of an invitation. Further, in certain embodiments, the media list can be sent absent second user registration.

In step 211 of the exemplified embodiment, the second user synchronizes its registered device 107, or network of devices, with the system 100 to update any newly licensed second user content to the AM server 102. In other embodiments, the second user content can use any means by which the system 100 can determine a second user licensed media list, that is, the list identifying the plurality of media items maintained and licensed by the second user device 107. In the exemplified embodiment, the licensed media list includes any licensed media items maintained by the second user, including those stored on the second user device 107 and those stored in other locations (such as in the cloud). In other embodiments, the licensed media list can be limited to those media items stored on the second user device 107.

Once the second user licensed media list is updated to the AM server 102, in step 212, the AM server 102 can perform a license query function on the second user's licensed media list to compare and match the content to be shared from the first user chosen media list to determine whether the second user has any existing licenses to own any media items identified in the first user chosen media list. In other words, the system 100 compares the licensed media list of the second user with the chosen media list of the first user to identify any common media items, that is, media items common to both lists.

In step 213 of the exemplified embodiment, the AM server 102 can interface with the DRM server 104 to finalize all content licensing requirements, including any new second user licenses required on any media items authorized to be downloaded and owned by the second user. In step 214, the AM server calculates any cost discounts for the first user for any pre-existing licenses present within second user's licensed media list and processes the final discounted payment for the first user. Thus, the system 100 calculates a cost for the provision of the chosen media list to the second user, the cost including a charge for each media item of the at least one chosen media item not including the at least one common media item. In other embodiments, the cost for new licenses can be shared between the giver and recipient. In yet other embodiments, the cost can be borne entirely by the recipient.

Once payment by the first user is confirmed, the DRM server 104 can calculate and issue all service fees to content providers 108 via the Content Provider Interface (CPI) 205 for any newly licensed downloads authorized for the second user to download and own as in step 215. A service fee can be any payment to the content providers 108, such as a royalty payment. In the exemplified embodiment, the service fee will not include any common media items to which the second user already has a license. In other embodiments, payment may include a discounted cost for any common media items for which the second user already has a license.

In step 216 of the exemplified embodiment, the AM server transfers downloads of any newly licensed media items to the second user device 107, the newly licensed media items not including any common media items. The second user can thus own, retain, and replay the shared content without having to access the system, as all such shared content becomes a part of the end user's permanent media library.

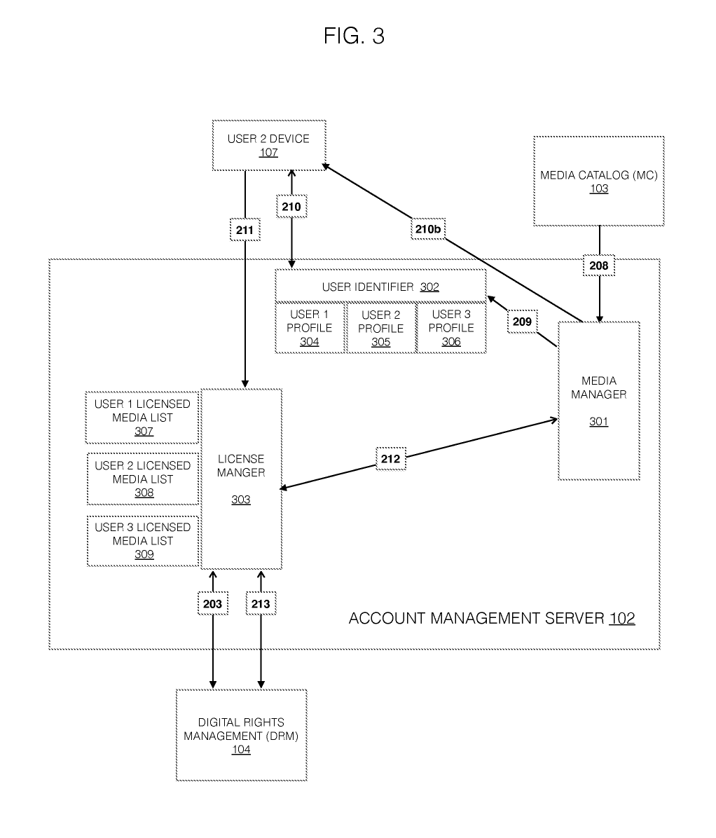

As shown in FIG. 3, in one embodiment, the account management (AM) server 102 may be implemented as a number of computer servers that are configured to process a request from a user to share content with another user. In particular, the AM server 102 includes a media manager 301, a user identifier 302, and a license manager 303. The media manager 301 is configured to interface with the media catalog (MC) server 103 to provide a user's selection of content to be shared with another user as in step 208. The user identifier 302 is configured to interface with the media manager 301 to verify a user's identity and current registration information to maintain the user profiles 304, 305, 306 as in step 209. The user identifier 302 is configured to contact a user regarding a request by another user to share content that will include a request for the user to register if such user is not a currently registered user of the system as in step 210. The license manager 303 is configured to synchronize a user's registered device anytime the user logs on to the system in order to update the user's licensed media list 307, 308, 309 as in step 211. The license manager 303 is configured to perform a license query function by interfacing with the media manager 301 to compare and match the content being shared from one user to another so as to prevent any duplicate licensing of content on the system as in step 212. The license manager 303 is further configured to interface with the digital rights management (DRM) server 104 to confirm and finalize all content licensing requirements, including any new end user licenses required for a user to download and own shared content as in steps 203 and 213.

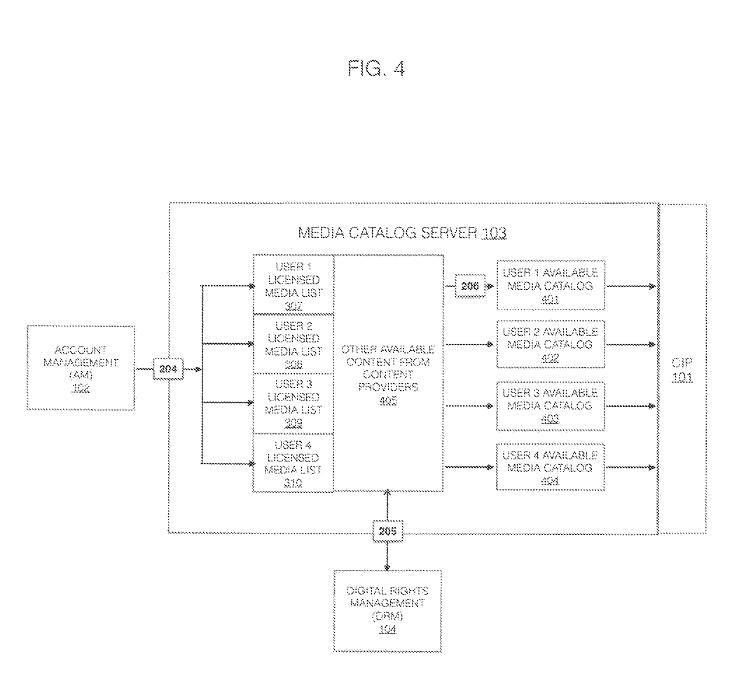

Referring now to FIG. 4, in one embodiment, the media catalog (MC) server 103 creates a licensed media list 307, 308, 309, 310 for each registered user using the content identifiers provided by account management (AM) server 102 as in step 204. The MC server 103 combines each registered user's licensed catalog with the content identifiers of other available content from all content providers 108 associated with the system through the digital rights management (DRM) server 104 as in step 205. The MC server 103 is configured to create an available media catalog for each registered user 401, 402, 403, 404 from which each user can select content to share with other users as in step 206. Each user's available media catalog is obtained by the user's registered device through the customer interface portal (CIP) 101.

The embodiments described herein provide several advantages. For example, the embodiments provide an effective means of identifying media items common between a gifted playlist and a recipient's previously owned media items. Further, the embodiments provide means for reducing the transaction costs to the users of the system based on the common media items identified. Additionally, by allowing the transaction to proceed even though common media items are identified, more transactions will be conducted between users, creating a more efficient market for media.

The embodiments also provide a means for preventing the purchase of duplicate licenses for media items. This solves the long felt market need for users to be able to gift media items to another and know if the recipient already owns the media item without having to ask the recipient. This will encourage the sharing of media playlists and media items further enhancing the efficiency of the media market. Further, by providing a simplified and cost effective method for media consumers to gift and share music, the embodiments can provide consumers with a convenient and legal alternative to piracy, thus helping resolve an ongoing problem for the media industry.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A system for sharing media items, the system comprising:
a customer interface portal configured to:
receive from a first user a chosen media list identifying at least one chosen media item; and
receive a request from the first user to provide the chosen media list to a second user;
an account management server configured to:
send to the second user the chosen media list;
receive a licensed media list from a second user device, the licensed media list identifying licensed media items maintained by the second user device, the licensed media items being owned by the second user;
compare the licensed media list of the second user to the chosen media list of the first user and identify at least one common media item, the at least one common media item being common to both the licensed media list and the chosen media list;
calculate a cost for the provision of the chosen media list to the second user, the cost including a charge for each media item of the at least one chosen media item not including the at least one common media item;
confirm payment of the cost by the first user;
calculate and issue a service fee to a content provider; and
transfer to the second user for download each media item of the at least one chosen media item not including the at least one common media item.

2. The system of claim 1 wherein the account management server is further configured to:
transmit an invitation to the second user to receive the chosen media list; and
receive from the second user an acceptance of the invitation.

3. The system of claim 2 wherein the invitation to the second user is transmitted by an email.

4. The system of claim 1 wherein the licensed media items maintained by the second user device are stored on the second user device.

5. The system of claim 1 wherein:
the customer interface portal is further configured to receive a first user licensed media list, the first user licensed list identifying a plurality of first user media items maintained by the first user device;
the account management server is further configured to receive the first user licensed media list;
a digital rights management server is configured to receive the first user licensed media list from the account management server to determine whether each of the plurality of first user media items is licensed; and
a media catalog server is configured to:
receive the first user licensed media list from the account management server;
create an available media catalog based on the first user licensed media list, the available media catalog identifying a plurality of available media items, the at least one chosen media item being a subset of the plurality of available media items; and
transmit the available media catalog to the customer interface portal.

6. The system of claim 5 wherein the available media catalog is further based on a plurality of system available media items made available by registered content providers.

7. The system of claim 1 wherein the chosen media list comprises a list of songs.

8. The system of claim 1 wherein the at least one common media item comprises a plurality of common media items common to both the first user's chosen media list and the second user's licensed media list.

9. The system of claim 1 wherein the account management server is further configured to prompt the second user to complete a registration process before receiving the licensed media list from the second user device.

10. A method for sharing media items, the method comprising:
receiving from a first user a chosen media list identifying at least one chosen media item;
receiving a request from the first user to provide the chosen media list to a second user;
sending to the second user the chosen media list;
receiving a licensed media list from a second user device, the licensed media list identifying licensed media items maintained by the second user device, the licensed media items being owned by the second user;
comparing the licensed media list of the second user with the chosen media list of the first user to identify at least one common media item;
calculating a cost for the provision of the chosen media list to the second user, the cost including a charge for each media item of the at least one chosen media item not including the at least one common media item;
confirming payment of the cost by the first user;
calculating and issuing a service fee to a content provider; and
transferring to the second user for download each media item of the at least one chosen media item not including the at least one common media item.

11. The method of claim 10 further comprising:
transmitting an invitation to the second user to receive the chosen media list; and
receiving from the second user an acceptance of the invitation.

12. The method of claim 11 wherein the invitation to the second user is transmitted by an email.

13. The method of claim 10 wherein the licensed media items maintained by the second user device are stored on the second user device.

14. The method of claim 10 further comprising:
providing the first user access to an available media catalog, the available media catalog identifying a plurality of available media items comprising:
system-available media items made available by registered content providers; and
unique media items stored on a first user device and not included in the system-available media items; and
wherein the at least one chosen media item is a subset of the plurality of available media items.

15. The method of claim 10 wherein the chosen media list comprises a playlist of songs.

16. The method of claim 10 wherein the at least one common media item comprises a plurality of common media items common to both the first user's chosen media list and the second user's licensed media list.

17. The method of claim 10 further comprising:
requiring the second user to complete a registration process before receiving the licensed media list from the second user device.

18. A method for sharing media items, the method comprising:
receiving from a first user a chosen media list identifying at least one chosen media item;
receiving a request from the first user to provide the chosen media list to a second user;
sending to the second user the chosen media list;
receiving a licensed media list from a second user device, the licensed media list identifying licensed media items maintained by the second user device, the licensed media items being owned by the second user;
comparing the licensed media list of the second user with the chosen media list of the first user to identify at least one common media item;
calculating a cost for the provision of the chosen media list to the second user, the cost including (a) a first charge for each of the at least one common media item, and (b) a second charge for each of the at least one chosen media item that is not the at least one common media item, wherein the first charge is less than the second charge;
confirming payment of the cost by the first user; and
transferring to the second user for download each media item of the at least one chosen media item not including the at least one common media item.

19. The method of claim 18 further comprising:
transmitting an invitation to the second user to receive the chosen media list; and
receiving from the second user an acceptance of the invitation.

20. The method of claim 18 further comprising:
calculating and issuing a service fee to a content provider.
